(19) United States
(12) Patent Application Publication
(10) Pub. No.: US 2016/0131348 A1
(43) Pub. Date: May 12, 2016

(54) Mountable and Retractable Lighting System

(71) Applicants: Todd M. Rima, Olate, KS (US); Larry R. Hutchison, Overland Park, KS (US)

(72) Inventors: Todd M. Rima, Olate, KS (US); Larry R. Hutchison, Overland Park, KS (US)

(21) Appl. No.: 14/937,534

(22) Filed: Nov. 10, 2015

Related U.S. Application Data
(60) Provisional application No. 62/077,392, filed on Nov. 10, 2014.

(51) Int. Cl. F21V 21/15; F21V 23/00; F21V 33/00; F21V 15/01

(52) U.S. Cl. CPC F21V 21/15; F21V 15/01; F21V 23/003; F21V 33/0056; F21Y 2101/02; F21W 2121/004

(57) ABSTRACT

An adjustable lighting system for installation on the side walls of a building. The lighting system includes a motor and gears that lower lights when the system is activated and retract them when deactivated, thereby keeping the system hidden from view when not in use. The device is controlled by a mobile application which lowers the lighting units, adjusts the brightness of the lights, and can manipulate the lighting color patterns and designs. Additionally, the device can include speakers and the necessary circuitry in order to play audio.

### CROSS REFERENCE TO RELATED APPLICATIONS

This application claims the benefit of U.S. Provisional Application No. 62/077,392 filed on Nov. 10, 2014. The above identified patent application is herein incorporated by reference in its entirety to provide continuity of disclosure.

### BACKGROUND OF THE INVENTION

The present invention relates to lighting systems, in particular, to lighting systems that are configured to be mounted on the surface of a structure and that are designed to be lowered when in use and retracted and hidden behind a cover when not in use.

Exterior and interior lighting systems for houses often contain both pragmatic and aesthetic aspects. While the primary use of a lighting system is to brighten an area that is otherwise too dark for general use, lighting can also be designed to highlight the structural architecture or creative features of a building. Decorative lighting is often mounted on the outer walls of buildings and on the surrounding grounds and positioned to illuminate the structure.

One disadvantage of these lighting systems is that the lighting hardware, such as the socket and large lights bulbs, are visible even when not in use and can be unsightly both to the structure itself and to the surrounding land. Another disadvantage is that light fixtures that are installed on the ground can become dangerous obstacles to pedestrians and animals, especially when they are deliberately placed to be hidden from view.

Additionally, many of the current lighting systems are designed to be controlled via a timer switch, which must be set to a preselected schedule and it is often cumbersome to override in order to manually control the lights. Furthermore, the control ability of such switches on these systems is often limited to a binary on or off setting.

Therefore, there exists a need in the prior art for a lighting system that can be mounted or installed in such a way as to be inconspicuous to onlookers. Moreover, there exists a need for a system that can be controlled with a finer degree of customization both in terms of a schedule as well as in regard to the brightness and color of the lights.

### SUMMARY OF THE INVENTION

In view of the foregoing disadvantages inherent in the known types of lighting systems now present in the prior art, the present invention provides a lighting system wherein the same can be utilized for providing convenience for the user when illuminating an exterior or interior of a building. The present system comprises a housing, a member disposed inside the housing, a number of lights disposed on the member, and a mechanism to lower the member. The mechanism is made up of a motor and a set of gears, wherein one gear is attached to the motor and another is connected to the member. The member is lowered when the gears are engaged and activated by the motor. The present invention also comprises a transceiver and a logic, such as a microprocessor. The transceiver can receive instructions over a network connection and communicate those instructions to the motor via the logic.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic perspective view of an embodiment of the lighting system.

FIG. 2 shows a schematic perspective view of an alternative embodiment of the lighting system.

FIG. 3 shows a perspective view of an additional embodiment of the lighting system.

FIG. 4 shows a perspective view of the lighting system as installed on a structure.

### DETAILED DESCRIPTION OF THE INVENTION

Reference is made herein to the attached drawings. Like reference numerals are used throughout the drawings to depict like or similar elements of the lighting system. The figures are intended for representative purposes only and should not be considered to be limiting in any respect. As used herein, “logic” refers to (i) logic implemented as computer instructions and/or data within one or more computer processes and/or (ii) logic implemented in electronic circuitry.

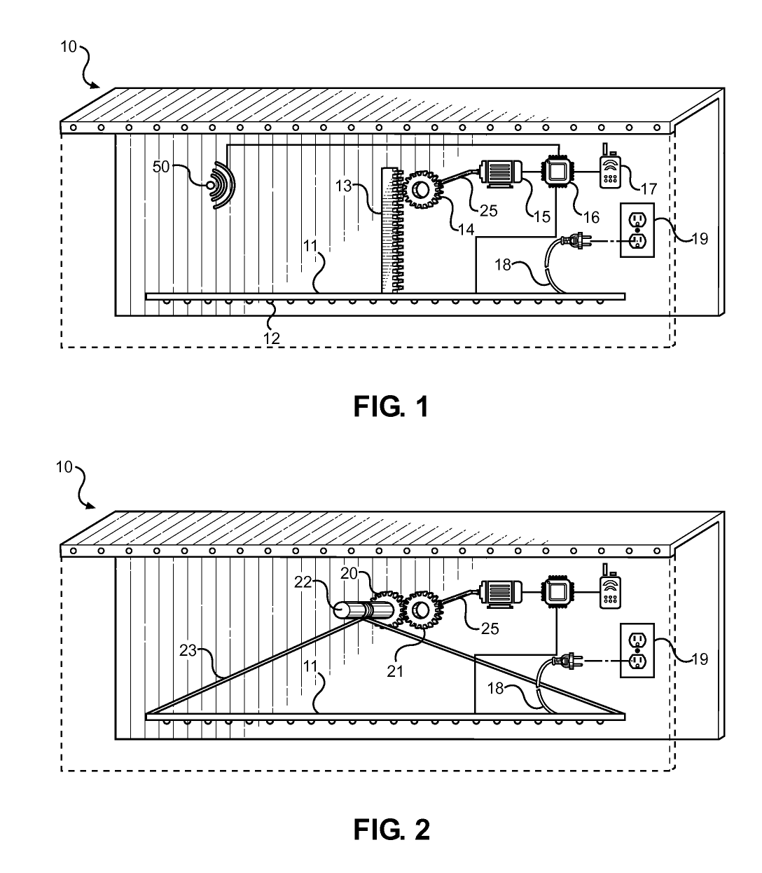

Referring now to FIG. 1, there is shown a schematic perspective view of an embodiment of the lighting system. The lighting system comprises a housing 10, a member 11, a light 12, a first gear 13, a second gear 14, a motor 15, a logic 16 and a transceiver 17. The lights are 12 disposed along the member 11. The light 12 are operably connected to a power supply 19 through electrical wiring 18. The member 11 is connected to a first gear 13 that is positioned to engage with a second gear 14. The second gear 14 is operably connected to a motor 15, such that when the motor 15 is engaged, the gears 13, 14 adjust the position of the member 11. The motor 15 is operably connected to a logic 16, such as a microprocessor. The logic 16 is configured to control the motor 15, which in turn allows the logic 16 to control the direction and rate of movement of the member 11.

In one embodiment, the first gear 13 and second gear 14 is a rack and pinion style gear, wherein the first gear 13 is an elongated straight shaft with teeth extending from the member 11 and the second gear 14 is a circular gear with complementary teeth attached to the motor 15 via a first rod 25. The motor 15 and second gear 14 are mounted in a fixed position onto the housing 10. When the motor 15 is activated it rotates the attached second gear 14 about an axis through the rotation of the first rod 25. The second gear 14 engages the first gear 13 and the member 11 is then extended or retracted depending upon the direction of rotation imparted by the motor 15 on the second gear 14.

The microprocessor 16 is operably connected to transceiver 17, to the motor 15 and to the lights 12. The transceiver 17 is configured to communicate with a device, such as a mobile electronic device or a computer, through a short range wireless communication protocol, such as Bluetooth. The mobile device is then able to control the extension and retraction of the member, whether the lights are activated, and other such variables associated with the present lighting system via sending and receiving wireless communication signals to the logic 16 via the transceiver 17. In another embodiment of the invention, the transceiver 17 is configured to communicate with a device, such as a mobile electronic device or a personal computer, through a telecommunication network, such as the internet, utilizing either a wired or a wireless connection to a network router. The microprocessor 16 can then be controlled through any device that is configured to communicate with the transceiver 17 over that telecommunication network. Additionally, the mobile device or personal computer can control the scheduling of the invention. For example, a mobile device can relay to the microprocessor 16 that the member 11 should be lowered and the lights 12 activated from dusk until midnight, at which point the lights are to be deactivated and the member 11 retracted into the housing 10. The microprocessor 16 relays these instructions to the motor 15 and to the lights 12 at the correct times. In an alternative embodiment of the invention, there is an additional manual switch operably connected to the microprocessor 16 that enables control of the lights 12 and motor 15 without use of a wired or wireless network.

In one embodiment of the invention, the lights 12 are light sockets adapted to connect to screw-type bulbs. In another embodiment of the invention, the lights are light emitting diodes that are capable of emitting light of varying brightness and of varying colors. These light emitting diodes are in communication with the microprocessor 16, which is configured to control both the brightness and the colors. In another embodiment of the invention, there is a sound system that is integrated with the invention. The sound system comprises audio speakers 50 that are in communication with the microprocessor 16. The microprocessor 16 is configured to play audio that is transmitted through the transceiver 17 through the audio speakers 50. The audio speakers 50 can be integrated with the lights 12. For example, the microprocessor 16 can control the brightness and colors of the lights 12 to correspond aesthetically with the rhythm and volume of the audio being played through the audio speakers 50.

Referring now to FIG. 2, there is shown a schematic perspective view of an alternative embodiment of the invention. The member 11 is supported by a cable assembly. In one embodiment, the member 23 is supported by two cables 23. The first end of each cable 23 is attached to the member 11. The second end of each cable 23 is wound around a second rod 22 that is connected to the first gear 20. In this embodiment of the invention, both the first gear 20 and the second gear 21 are circular gears. When the microprocessor 16 relays instructions to the motor 15 to rotate the second gear 21 via the first rod 25, the first gear 20 is engaged and rotates the attached second rod about an axis, causing the cable 23 to wrap around the rod 26 and retract the member 11. When the gears turn in the opposite direction, the rope 23 is unwound and the member 11 is extended.

In another embodiment of the invention, a first cable 23 is attached to both ends of the member 11. There is a second cable, wherein one end of the second cable is secured to the middle of the first cable, and the other end of the second cable is wound around the second rod 22. When the motor activates the gears 20, 21 via the rod 25, the second cable is wound around the second rod 22 and the member 11 is retracted into the housing 10. When the motor turns the gears 20, 21 in the opposite direction, the member 11 is extended outside of the housing 10.

In another embodiment of the invention, the mechanism used to extend and retract the member 11 is a direct mechanical apparatus. For example, the motor 15 is directly attached to a rod that is connected to the member 11 such that when the motor 15 is engaged, the rod rotates about an axis and the member 11 is extended or retraced. In another embodiment of the invention, the motor is operably connected to a pneumatic piston, wherein the piston is attached to the member 11. When the motor is engaged, the piston is retracted or extended, and in turn retracts of extends the member 11 as well.

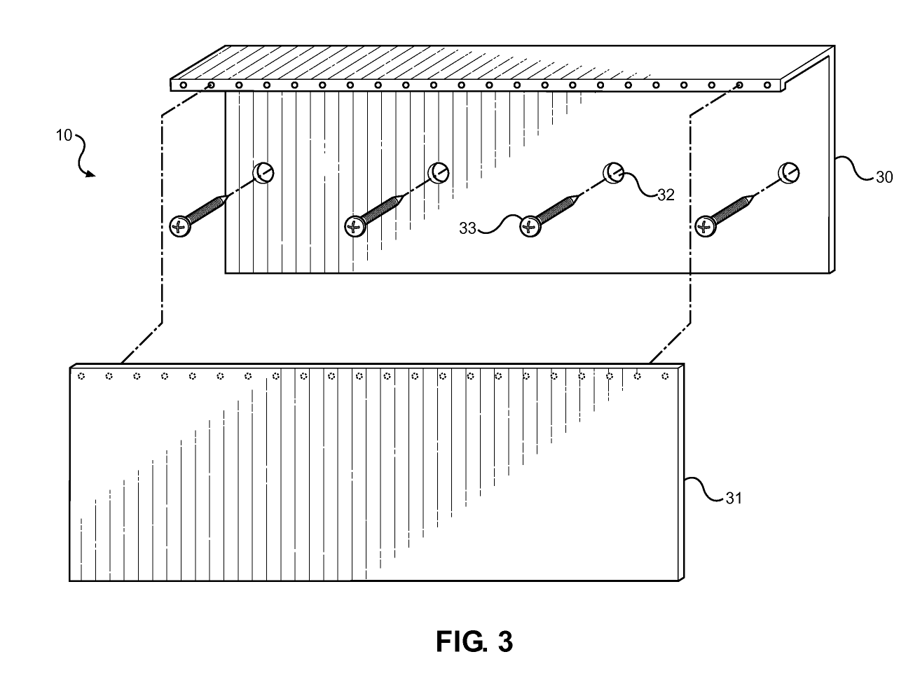

Referring to FIG. 3, there is shown a perspective view of an alternative embodiment of the invention. The housing 10 comprises a first element 30 and a second element 31. The first element 30 is mounted to the side of a structure, such as an exterior wall, and the second element 31 is attached to the first element 30 by a fastening device, such as a screw. The second element 31 is designed to aesthetically complement the surroundings where it is to be mounted. This embodiment allows for multiple first elements to be interchanged, depending on the appearance desired by a user.

Another embodiment of the invention includes apertures 32 in the housing 10 which are configured to allow a fastening device to attach the housing 10 to a structure. For example, bolts 33 can be used to pass through the housing 10 and secure it to the wall of a building.

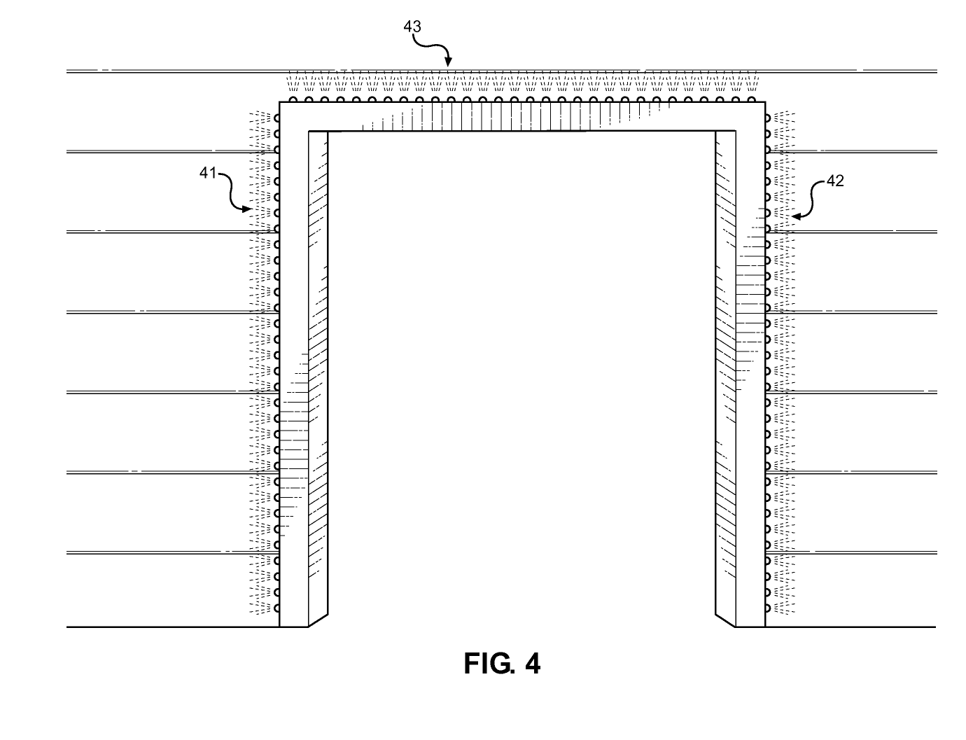

Referring to FIG. 4, there is shown a perspective view of the invention as it appears when mounted on the sides of an exterior doorway. The lights 12 can be placed in a manner to highlight the structure of the building. For example, to light the perimeter of a doorway, there can be three members mounted to the doorway, one member on each doorpost 41, 42 and one member on the lintel 43. Alternatively, there can be a U-shaped member with a mechanism that extends and retracts the entire member at once. Similarly, the invention can be mounted in various interior locations of a structure.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An adjustable lighting system, comprising:
a housing;
a member disposed inside the housing;
a light socket disposed on the member and operably connected to a power supply;
a motor mounted to the housing;
a mechanical apparatus operably connected to the motor;
a logic operably connected to the motor, the logic configured to activate the motor and thereby control the extension and retraction of the member via the mechanical apparatus;
a transceiver in communication with the logic, wherein the transceiver is configured to receive instructions from a device and relay the instructions to the logic.

2) The adjustable lighting system of claim 1, where the mechanical apparatus comprises:
a first gear operably connected to the motor;
a second gear engaged with the first gear, wherein the first gear and the second gear are configured to adjust the position of the member when the motor is activated;

3) The adjustable lighting system of claim 1, wherein the housing is further configured to be mounted onto a surface of a structure.

4) The adjustable lighting system of claim 1, wherein the logic is configured to control the brightness of a light bulb attached to the member through the light socket.

5) The adjustable lighting system of claim 1, wherein the logic is configured to control the color of a light bulb attached to the member through the light socket.

6) The adjustable lighting system of claim 1, further comprising an audio speaker operably connected to the logic, wherein the logic is configured to play audio from an audio source through the speaker.

7) The adjustable lighting system of claim 1, wherein the housing comprises an exterior portion configured to conceal the member when the member is in a retracted position.

8) An adjustable lighting system, comprising:
a housing;
a member disposed inside the housing;
a light emitting diode disposed on the member and operably connected to a power supply;
a motor mounted to the housing;
a first gear operably connected to the motor;
a second gear engaged with the first gear, wherein the first gear and the second gear are configured to adjust the position of the member when the motor is activated;
a logic operably connected to the motor, the logic configured to activate the motor and thereby control the extension and retraction of the member;
a transceiver in communication with the logic, wherein the transceiver is configured to receive instructions from a device and relay the instructions to the logic.

9) The adjustable lighting system of claim 8, where the mechanical apparatus comprises:
a first gear operably connected to the motor;
a second gear engaged with the first gear, wherein the first gear and the second gear are configured to adjust the position of the member when the motor is activated;

10) The adjustable lighting system of claim 8, wherein the housing is further configured to be mounted onto a surface of a structure.

11) The adjustable lighting system of claim 8, wherein the logic is configured to control the brightness of the light emitting diode attached to the member.

12) The adjustable lighting system of claim 8, wherein the logic is configured to control the color of the light emitting diode attached to the member.

13) The adjustable lighting system of claim 8, further comprising an audio speaker operably connected to the logic, wherein the logic is configured to play audio from an audio source through the speaker.

14) The adjustable lighting system of claim 8, wherein the housing comprises an exterior portion configured to conceal the member when the member is in a retracted position.
